(19) United States
(12) Patent Application Publication
(10) Pub. No.: US 2002/0121868 A1
(43) Pub. Date: Sep. 5, 2002

(54) Level shifter in a picture display device

(76) Inventors: Petrus Johannes Gerardus Van Lieshout, Eindhoven (NL); Pieter Johannes Engelaar, Eindhoven (NL)

Correspondence Address: U.S. Philips Corporation, 580 White Plains Road, Tarrytown, NY, 10591, US

(21) Appl. No.: 10/024,774

(22) Filed: Dec. 20, 2001

(30) Foreign Application Priority Data
Dec. 22, 2000 (EP) 00204804.9

(51) Int. Cl. H01J 29/70

(52) U.S. Cl. 315/387; 315/390

(57) ABSTRACT

The present invention relates to a picture display device having a cathode ray tube (2), control means (50) for controlling the electron beam/beams of the cathode ray tube (2), an indexing element (12, 14) for determining whether the electron beam/beams impinges at the correct location, and a feedback system for providing the control means (50) with a signal generated by the indexing means (12,14). The feedback system comprises a level shifter (30) for transferring the signal from a high-voltage system (20) of the cathode ray tube and the indexing elements (12, 14) to a low-voltage system (22) of the control means (50). In order to provide the level shifter (30) with the capacity of transferring signals comprising high frequencies, the level shifter (30) is provided with an input stage (32a, 32b) arranged to decrease the input impedance of the level shifter (30).

### FIELD OF THE INVENTION

The present invention relates to a picture display device comprising a cathode ray tube (CRT) provided with indexing elements for detecting an electron beam of the CRT that impinges on said elements, and a level shifter for transmitting of at least one signal, based on the detection at the indexing elements, from a high-voltage system of the CRT to a low voltage system of an electron beam control means.

### BACKGROUND OF THE INVENTION

A problem, which occurs in picture display devices having a CRT for presenting images is, for example, directing the electron beam or beams of the CRT to an intended position with precision, i.e. without much deviation. Another problem, which often occurs, is in presenting a beam spot having an optimal shape. These problems could be corrected to a limited extent by calibrating the device during its manufacture. However, the calibration does not have any effect on the problems caused by other effects, such as influences of the earth's magnetic field or of other devices, low-frequency interference, etc, at the location where the picture display device is used. Low-frequency interference could, for example, originate from the mains (50 or 60 Hz), from neighbouring electric equipment generating stray fields, etc.

To overcome the above-mentioned problems, many solutions that comprise registration means for determining the position of an electron beam have been presented. One common solution is to provide the CRT with some kind of indexing element that detects the amount of electrons impinging from an electron beam onto the indexing element. The indexing element then generates a signal which is proportional to the amount of impinging electrons. The signal is then sent via a feedback loop to control means controlling the direction of the electron beam and the shape of the impinging beam spot. Thus, any errors regarding the direction of the electron beam or the shape of the impinging beam spot that occur during operation of the picture display device can be corrected by the control means.

The CRT and the indexing elements of a picture display device are generally at a very high-voltage (25-30 kV). It is difficult and potentially hazardous to perform measurements at such high-voltages. Therefore, the signal from the indexing elements has to be converted to a low-voltage signal. Such an operation is generally referred to as a level shift.

EP 0 163 741 describes a beam-indexing colour cathode-ray tube having indexing elements arranged on a phosphor screen. The indexing elements are arranged as stripes extending across the screen and are grouped in two electrically separated groups, a first and a second group. The stripes are arranged so that a stripe of the first group is positioned adjacent to a stripe of the second group. The stripes are conductive and provide a signal when electrons impinge on them. To check whether the electron beam impinges correctly, the signal from each group is transferred to control means. The signal from each group is sent via capacitors to a differential amplifier, which operates as a subtractor. Thus the signal from the subtractor represents the difference between the signals from the two groups and is sent to control means for controlling the direction of the electron beams.

U.S. Pat. No. 4,635,107 describes a picture display device which is similar to the above-mentioned one. The device comprises indexing elements arranged on a screen. The indexing elements generate signals corresponding to impinging electrons and they are arranged in two groups. The two groups are connected to each other via a primary winding of a coupling transformer. The transformer provides insulation between the high-voltage potential of the screen and the ground reference of the processing circuitry coupled to the secondary winding. The signal from the secondary winding is then used in control means for controlling the electron beam of the CRT.

EP 0 382 838 describes a CRT having a shadow mask or another type of screen grid. The screen grid comprises a plurality of apertures. The electron beams of a CRT intersect at the position of the apertures and diverge after passing through the aperture in order to impinge on different phosphor elements on a display screen of the CRT. The screen grid is connected to the display screen via a current-sensing means generating a signal for use in a control system. The current-sensing means is either a coil or a LED, which transfers the signal to a pick-up coil or a photo-diode. Thus, the control system circuits become insulated isolated from the high-voltage of the CRT .

In WO 00/38212, which is considered the most pertinent prior art, a CRT is described having indexing elements arranged on a display screen of the CRT. The indexing elements are arranged in two groups. The indexing elements from one group are positioned adjacent to elements from the other group and are electrically conductive. Thus, the index elements generate signals corresponding to the amount of electrons impinging on them. In this document, the index elements are also arranged in different patterns, which are utilized for controlling different characteristics of the behaviour of the electron beam. The signal generated by the groups of a pattern is provided as an input signal to a differential amplifier. The amplified differential signal is then sent via a “level shifter” to control means for controlling the electron beam of the CRT. The level shifter is either a magnetic transformer (inductive voltage transfer), an electric transformer (capacitive voltage transfer), or an optical transformer (transfer by means of light). The level shifter is directly connected to the differential amplifier.

One problem of providing the control means with a feedback signal is that the level shifter of the feedback loop limits the bandwidth.

### SUMMARY OF THE INVENTION

It is an object of the present invention to provide a level shifter in a picture display device that does not limit the bandwidth of the feedback loop.

This is accomplished by means of a picture display device as defined in claim 1. Preferred embodiments of the invention are defined in the dependent claims.

More particularly according to one embodiment of the invention, the picture display device comprises a cathode ray tube (CRT) provided with index elements for detecting an electron beam of the CRT that impinges on said elements. The picture display device also comprises a level shifter for transmitting of at least one signal, based on the detection at the index elements, from a high-voltage system of the CRT to a low-voltage system of an electron beam control means. Furthermore, the picture display device is characterized in that the level shifter comprises an input stage arranged to decrease the input impedance of the level shifter.

In picture display devices according to the invention, there is a capacitive effect between the index elements and the anode of the CRT. This capacitive effect in combination with the input impedance of the level shifter results in a pole in the transfer function of the level shifter. By providing the level shifter with an input stage that reduces the input impedance to the level shifter, the pole is moved to a higher frequency. The effect of moving the pole to a higher frequency is that the bandwidth of the level shifter increases. Thus, by arranging the input stage of the level shifter to decrease the input impedance of the level shifter, an increase in bandwidth through the level shifter is accomplished.

In one embodiment of the invention, the input stage of the level shifter comprises a current mirror for decreasing the input impedance. One advantage of using a current mirror is that the input impedance of the level shifter can be then controlled and optimized in order to present the optimal performance of the level shifter. Other advantages of using a current mirror are that it is cheap and easy to integrate in an Integrated Circuit (IC).

According to another aspect of the invention, the input stage of the level shifter comprises an inverting IN-converter (current to voltage converter) for decreasing the input impedance. The advantages of this embodiment are that it is quite cheap, easy to implement, able to withstand voltages forced onto the input stage, and that component mismatch does not deteriorate the circuit performance. However, it is not as easy to integrate in an IC as the current mirror. A drawback of the I/V-converter solution is that its inductive behaviour, together with the capacitance between the index elements and the anode of the CRT, can give rise to resonance.

According to yet another aspect of the invention, the input stage of the level shifter comprises two cascaded operational amplifiers and a feedback connection connecting an output of the last operational amplifier to an input of the first operational amplifier. One advantage of this embodiment is that it is more stable than the single I/V-converter and that possible resonance is easier to damp. Other advantages of this embodiment are that the input stage is able to withstand voltages forced onto them and that component mismatch does not deteriorate the circuit performance.

In a preferred embodiment of the invention, the signal in transmitted from the high-voltage system to the low-voltage system via an optical signal path. This embodiment makes it possible to provide galvanic separation between the high-voltage system and the low-voltage system. Furthermore, the optical path is very insensitive regarding interference originating from the environment. Such interference could, for example, be magnetic fields from home appliances or other devices.

According to yet another preferred embodiment, a first and a second indexing element are arranged adjacent to each other. This arrangement makes it possible not only to indicate that an electron beam impinges at the wrong location on the screen of the picture display device, but also to determine at what distance and in which direction from the intended location the electron spot really impinges. In a preferred embodiment, the control means is provided with a signal that corresponds to the difference between the signals received from the first and second index elements, respectively.

In summary, the present invention provides a picture display device having a cathode ray tube (CRT), control means for controlling the electron beam/beams of the cathode ray tube, an indexing element for determining whether the electron beam/beams impinges at the correct location, and a feedback system for providing the control means with a signal generated by the index means. The feedback system comprises a level shifter for transferring the signal from the high-voltage system of the CRT and the index elements to a low-voltage system of the control means. In order to provide the level shifter with the capacity of transferring signals comprising high frequencies, the level shifter is provided with an input stage arranged to decrease the input impedance of the level shifter.

### BRIEF DESCRIPTION OF THE DRAWINGS

The invention will now be described in more detail with reference to the accompanying drawings, wherein like reference numerals designate like structural elements, and in which:

FIG. 1 is a schematic view of a cathode ray tube in a picture display device according to a preferred embodiment of the invention,

FIG. 2 is a schematic view of a level shifter that could be used in the picture display device according to FIG. 2,

FIG. 3 is a schematic view of a preferred input stage to a level shifter according to FIG. 2,

FIG. 4a is a schematic view of another preferred input stage to a level shifter according to FIG. 2,

FIG. 4b is a diagram showing the gain and the input impedance of the input stage in FIG. 4a as a function of the frequency,

FIG. 5a is a schematic view of yet another preferred input stage to a level shifter according to FIG. 2,

FIG. 5b is a diagram showing the gain and the input impedance of the input stage in FIG. 5a as a function of the frequency,

FIG. 6 is a schematic view of a preferred embodiment of the level shifter according to FIG. 2,

FIG. 7 shows a preferred embodiment of the high-voltage side of the level shifter in FIG. 6,

FIG. 8 shows a preferred embodiment of the low-voltage side of the level shifter in FIG. 6,

FIG. 9 is a schematic view of another preferred embodiment of the level shifter according to FIG. 2,

FIG. 10 shows a preferred embodiment of the high-voltage side of the level shifter in FIG. 9,

FIG. 11 shows a preferred embodiment of the low-voltage side of the level shifter in FIG. 9,

FIG. 12 is a schematic view of another preferred embodiment of the level shifter according to FIG. 2, and

FIG. 13 is a schematic view of an auto-calibrating circuit positioned at the low-voltage side of a level shifter in a preferred embodiment.

### DETAILED DESCRIPTION OF PREFERRED EMBODIMENTS OF THE INVENTION

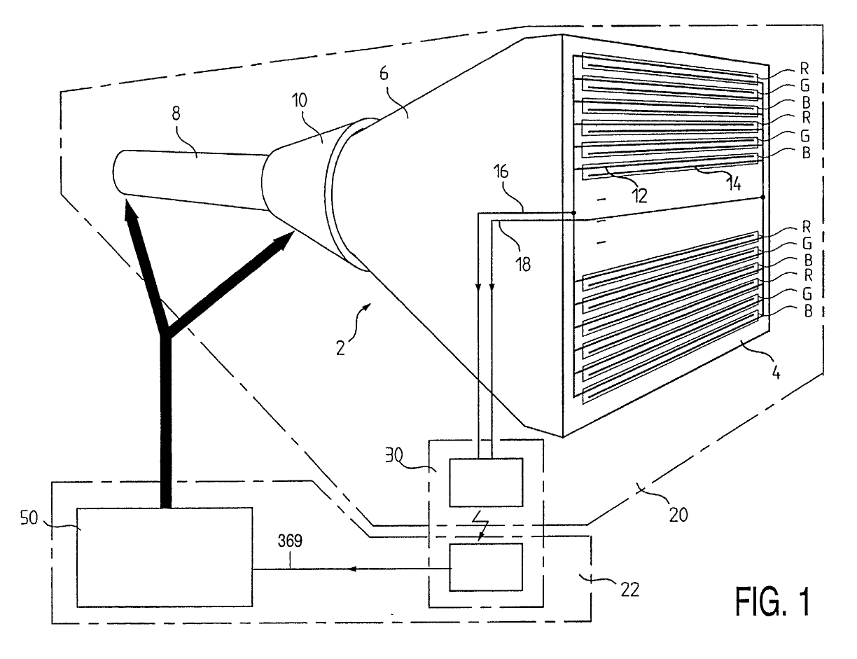

FIG. 1 shows a preferred embodiment of a cathode ray tube 2 (CRT) in a picture display device according to the invention. The CRT 2 comprises a display window 4, a cone 6, and a neck 8. The neck 8 accommodates an electron gun for generating electron beams. The electron beams are deflected across the display window 4 by means of a deflection device 10. The functionality of the electron gun and the deflection device is well known to persons skilled in the art and is therefore not further described.

The display window 4 is provided with phosphor elements, in this embodiment red (R), green (G), and blue (B), which transform the impinging electron beams to light and, thereby, images. At each phosphor element, arranged on the visible part of the screen, there are arranged two electrically separated index elements 12, 14, hereinafter referred to as first indexing element 12 and second indexing element 14, respectively. The first indexing element 12 of every phosphor element is electrically connected to an output conductor 16 and the second indexing element 14 of every phosphor element is electrically connected to an output conductor 18. When an electron beam evenly impinges on a first indexing element 12 and a second indexing element 14 of a phosphor element, there will be no difference in current flowing from the output conductors 16 and 18. The detection of differences in current is used to correct the electron beam of the CRT 2. It is also possible to provide the picture display device with additional patterns of index elements having output conductors of their own for controlling other properties of the electron beam, e.g. as described in WO 00/38212.

In order to control and adjust the electron beam, the deflection device 10 of the CRT 2 is controlled by control means 50. The properties and functions of the deflection device 10 are well known to a person skilled in the art. In a preferred embodiment the control means 50 is a microprocessor arranged to control the deflection device 10.

WO 00/38212 shows a possible drive of the deflection device 10 and also different means that could be present in said deflection device.

To optimize the performance of the picture display device, the signals from the index elements 12, 14 are sent to the control means 50 for evaluation and correction of the electron beam/beams. By using the signals inputted from the index elements 12, 14 and by controlling the deflection device 10, the control means 50 is able to adjust the performance of the picture display device continuously. However, the index elements 12, 14 are arranged in a high-voltage system 20 of the CRT 2, and the control means 50 is based on a low-voltage system 22. In order to transform the signals from the output conductors 16, 18, the feedback loop of the picture display device is provided with a level shifter 30. In a system comprising additional patterns of index elements, it is possible to provide one level shifter for each pattern.

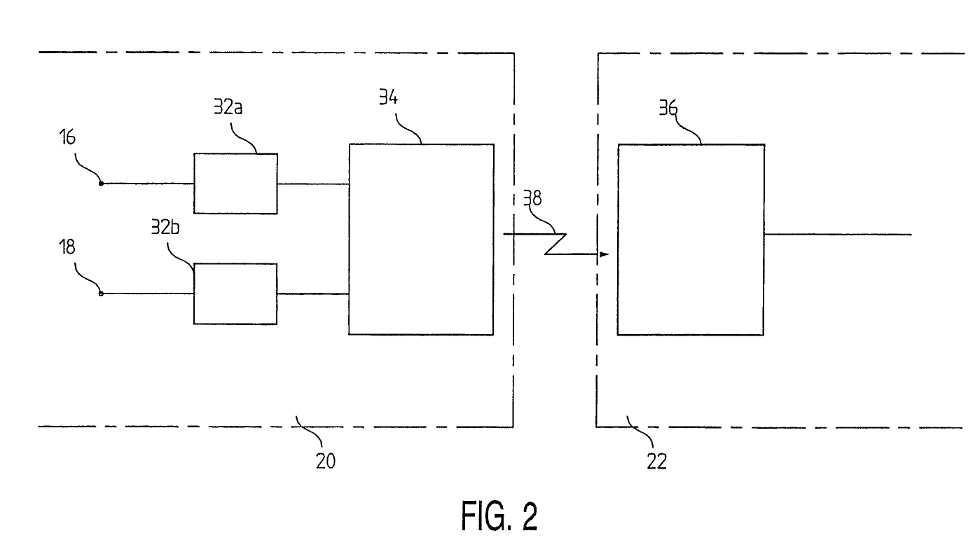

Now referring to FIG. 2, a preferred embodiment of the level shifter comprises one input stage 32a receiving the index signal from the output conductor 16, one input stage 32b receiving the index signal from the output conductor 18, circuitry 34 for handling and transmission of one or more signals at the high-voltage system, circuitry 36 for handling and reception of one or more signals at the low-voltage system, and an optical signal path 38 for the transmission of signals between the high-voltage system 20 and the low-voltage system 22. The purpose of the input stages is, essentially, to increase the bandwidth of the level shifter. According to the invention, this is accomplished by making the index signal experience a decreased input impedance, in relation to a level shifter which is not provided with an input stage according to the invention. By reducing the input impedance, the pole that is present in the transfer function of the level shifter is positioned at a higher frequency.

Thus, the level shifter is able to transfer index signals, which comprise higher frequencies, from the high-voltage system to the low-voltage system.

A detailed description of input stage embodiments will be given below. After the input stage, the signal/signals are sent via the optical path. The optical path is preferably formed by a Light Emitting Diode (LED) for transmitting the signal and a Photo-diode for receiving the signal. Thus, the level shifter provides both a change of voltage system for the signal, from the high-voltage system to the low-voltage system, and a galvanic separation between these systems.

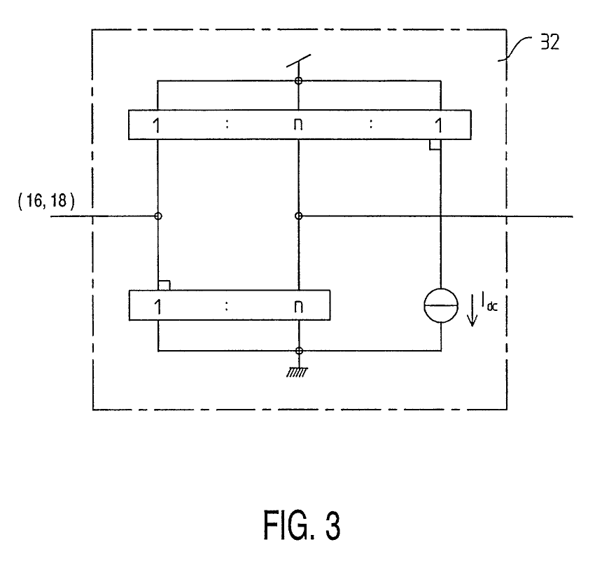

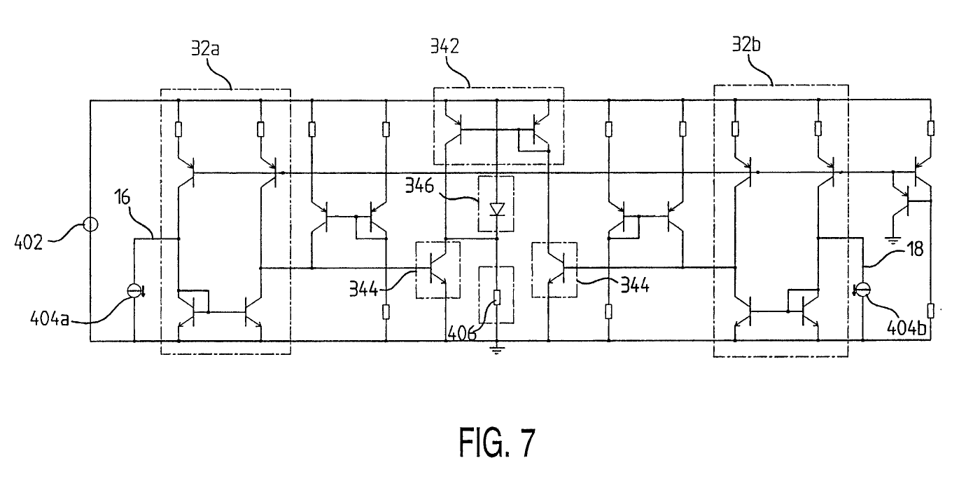

In a currently preferred embodiment of the invention, the input stage 32a, 32b comprises a current mirror, see FIG. 3, for decreasing the input impedance of the level shifter. The input impedance of the level shifter is adjusted by changing the value of the bias DC current Idc of the current mirror, and the current gain is adjusted by changing the mirror factor n. One implementation of a current mirror 32 in the input stage is shown in FIG. 7. In the currently preferred embodiment, the transistors used in the current mirror 32a, 32b have a low base resistance, a low emitter resistance, and a low collector resistance. The transistors are also very well-matched to each other.

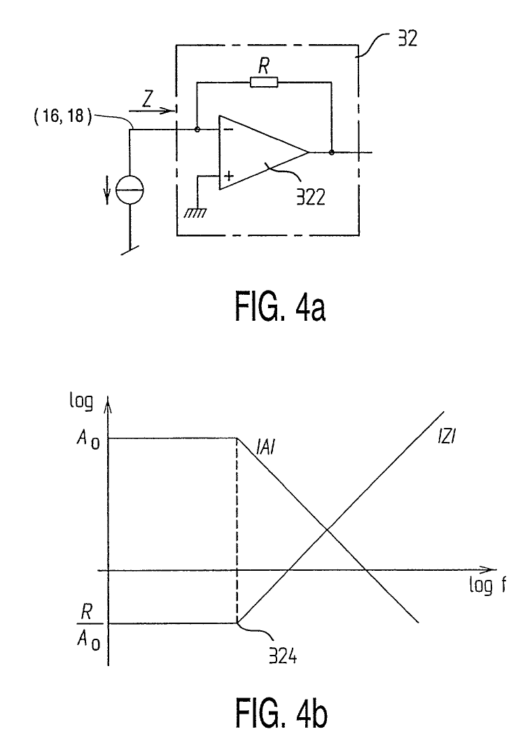

In another embodiment of the invention, the input stage is an inverting I/V-converter, as shown in FIG. 4a. This input stage comprises an operational amplifier 322 and a resistor R. The input impedance |Z| of the I/V-converter is inversely proportional to the open-loop gain A₀ of the operational amplifier 322. Thus, the input impedance will be very low up to a roll-off frequency. In FIG. 4b the input impedance |Z| and the gain of the operational amplifier |A| are presented as a function of the frequency f As discussed above the low input impedance |Z| is very low up to the roll-off frequency 324.

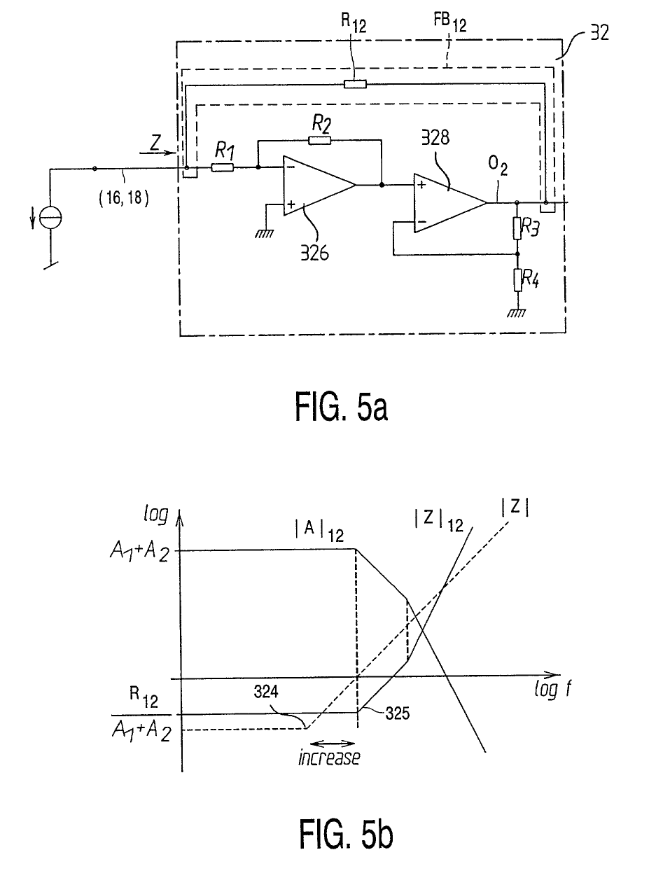

In yet another embodiment of the invention, the input stage comprises two cascaded operational amplifiers 326, 328, see FIG. 5a. In this embodiment, the needed forward gain is distributed across the two operational amplifiers. This makes it easy to stabilize the circuit and still make the input stage present a very low input impedance. The operational amplifier 326 is provided with a local feedback including the resistors R₁ and R₂, the operational amplifier 328 is also provided with a local feedback including the resistors R₃ and R₄, and the cascade of these two operational amplifiers 326, 328 is provided with a global feedback FB₁₂ including the resistor R₁₂ connecting the output O₂ of the last operational amplifier 328 to an input of the first operational amplifier 326. The voltage gain of the first operational amplifier 326 is

$${A}_{1} = \frac{{R}_{2}}{{R}_{1}}$$

and the voltage gain of the operational amplifier 328 is

$${A}_{2} = \frac{{R}_{3} + {R}_{4}}{{R}_{4}}$$

The product of these gain factors should be high in order to give the global feedback loop enough loop gain. The overall gain of the input stage 32 will then be determined by the global feedback resistor R₁₂ The input impedance |Z|₁₂ of this input stage 32 has a different frequency behaviour than the input stage in FIG. 4a. In FIG. 5b, the gain |Z||₁₂ and the input impedance |Z|₁₂ are shown as a function of the frequency. The dashed line |Z| depicts the input impedance shown in FIG. 4b. The roll-off frequency 325 of the input stage in FIG. 5a is positioned at a higher frequency than the roll-off frequency 324 of the input stage in FIG. 4a. However, the DC input impedance has increased slightly. The main advantage of the cascaded circuit, in relation to the I/V-converter, is that it is easier to apply because of a decreased inductive behaviour.

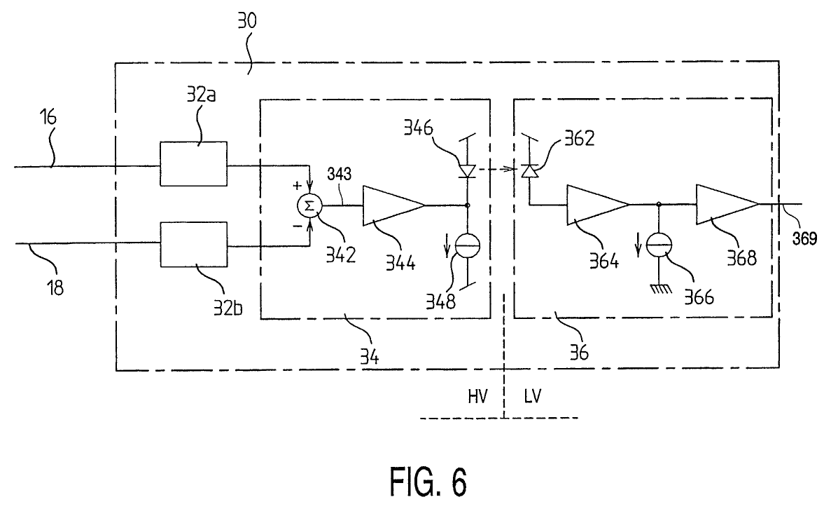

FIG. 6 is a schematic view of a preferred embodiment of the level shifter. The index signal from each group of index elements in an index pattern is inputted to the level shifter 30 via the conductors 16 and 18, respectively. The index conductors 16, 18 are connected to separate input stages 32a, 32b. The input stages 32a, 32b are of one of the types mentioned above. After the input stages 32a, 32b, the signals originating from the two different groups of index elements in the present index pattern are subtracted from each other in a subtraction circuit 342. Thus, the output signal 343 from the subtraction circuit 342 represents the difference between the two indexing signals and is hereinafter referred to as the differential signal. An amplifier 344 then amplifies the differential signal in order to optimize the amplitude of the differential signal in respect of the optical path. In the optical path, a LED 346 acts as a transmitter of the differential signal. The differential signal is superposed on a bias current that is generated by a current source 348. The bias current and the amplification of the differential signal are chosen to be such that the peak-to-peak value of the differential signal can be forwarded by the LED 346. Thus, the zero level of the differential signal is lifted by the bias current so that the sub-zero portions of the differential signal do not make the current driving the LED 346 to pass below zero.

The differential signal is thus transmitted through the optical path by means of the LED 346. For reception of the light-based differential signal, a photo-diode 362 is arranged at the receiving side of the optical path. The photo-diode 362 generates a current that is proportional to the amount of light received. Thus, the current corresponds to the differential signal superposed on the bias current at the transmitting side of the optical path. The received signal is then sent to an amplifier 364, which compensates for the attenuation of the signal resulting from the optical path. After the amplifier 364, the signal is compensated by means of a DC signal generated by a current generator 366. The current generator 366 is arranged to delete the portion of the signal that originates from the bias current applied to the differential signal before transmission through the optical path. The rest of the signal, which now corresponds to the original differential signal, is sent to an output gate 369 via a I/V-converter 368. The purpose of the I/V-converter 368 is to convert the current signal to a voltage signal for practical reasons.

The differential signal from the level shifter is then used as an input to a control means, e.g. a microprocessor, as described above.

FIG. 7 shows a preferred implementation of a preferred embodiment of the high-voltage HV side of the level shifter. The described implementation is a possible implementation of the high-voltage side HV of the embodiment shown in FIG. 6. The voltage source 402 in the Figure represents a local voltage supply for the high-voltage HV side of the level shifter. The current sources 404a-b correspond to the electron gun and the current generated when an electron beam impinges on the groups of index elements, respectively. Thus the conductors 16, 18 correspond to the output conductors having the same reference numerals in the previous Figures. In this embodiment, the input stages are implemented as current mirrors 32a-b. When the index signals have passed through the input stages 32a and 32b, respectively, the amplifiers 344 handle them. Then the index signals are fed to the subtraction circuit 342, which generates the differential signal. The bias current for the LED 346 is provided by means of a current source implemented as a resistor 406.

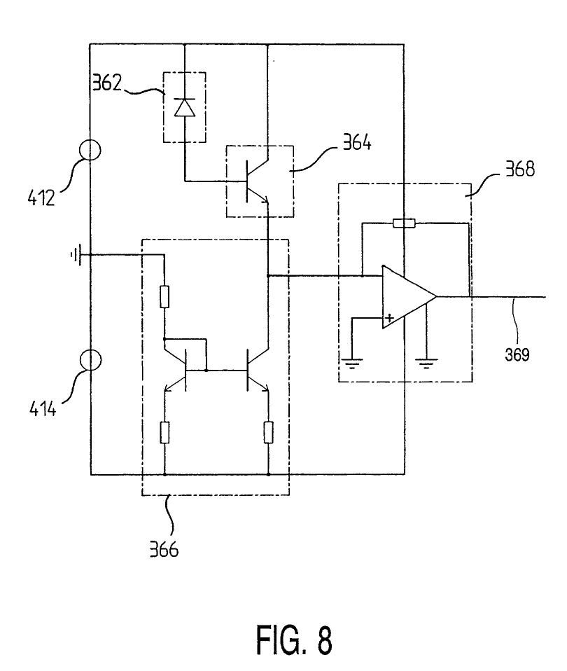

FIG. 8 shows a preferred implementation of a preferred embodiment of the low voltage side LV of the level shifter according to FIG. 6. The described implementation is a possible implementation of the low-voltage side LV of the embodiment shown in FIG. 6. The implementation utilizes one positive voltage feed and one negative voltage feed, illustrated by the voltage sources 412 and 414, respectively. The light from the LED at the high-voltage side is received by the photo-diode 362. The photo-diode 362 generates a signal proportional to the received light and the signal is forwarded to the amplifier 364. Then the signal is compensated by subtraction of a current corresponding to the bias current applied to the signal at the high-voltage side. This compensation is performed at the DC-compensation stage 366. The signal is then outputted to the control means via an I/V-converter 368.

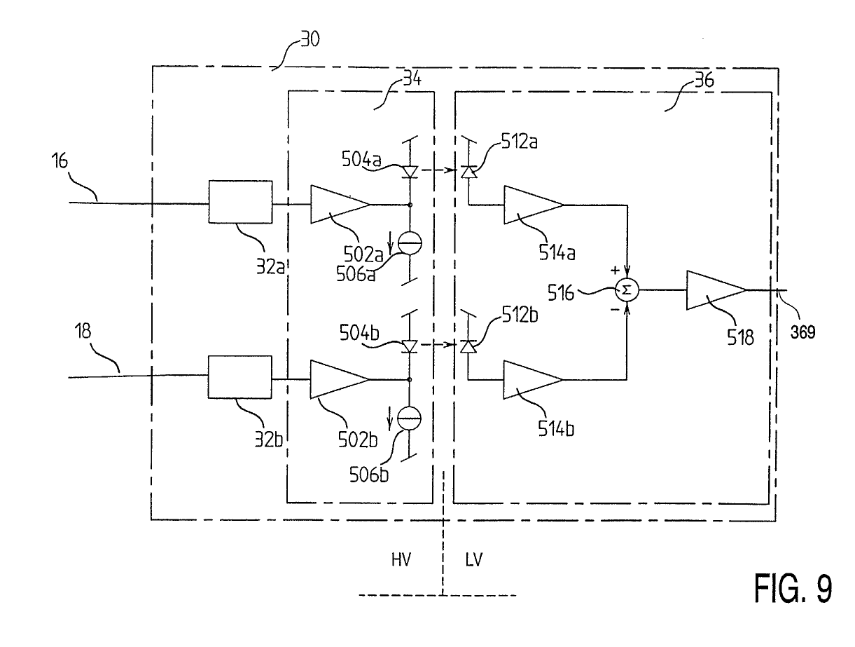

FIG. 9 is a schematic view of another embodiment of the level shifter. In this embodiment, the indexing signal from each group of index elements 16,18 is treated separately at the high-voltage side HV of the level shifter. The signals are not subtracted from each other until they have reached the low voltage side LV. Thus, the embodiment comprises one signal path for each indexing signal at the high-voltage side. Each signal passes through an input stage 32a-b, and an amplifier 502a-b, which amplifies the signal in order to optimize the amplitude of the differential signal in respect of the optical path. The indexing signals are then transmitted via an optical path by means of a LED 504a-b. Before the signals are transmitted, each indexing signal is superposed to a bias current 506a-b in the same manner as for the differential signal in FIG. 6.

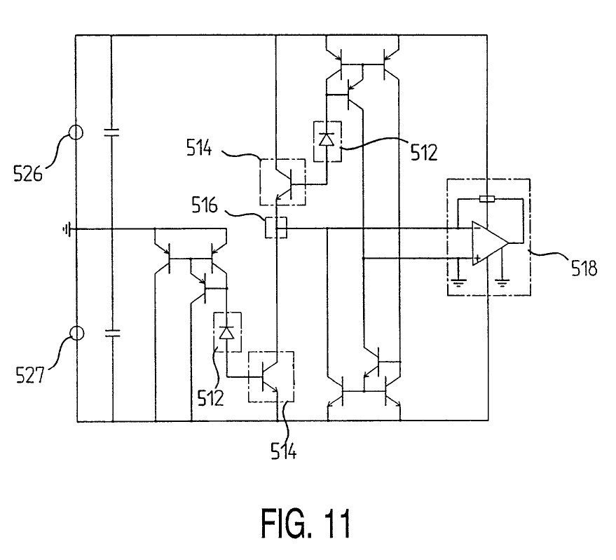

At the low-voltage side LV, each biased index signal is received by a photo-diode 512a-b. The photo-diode generates a signal proportional to the light impinging on it. Thus, each photo-diode generates a signal proportional to a biased index signal. Each biased index signal then passes through an amplifier 514a-b, which compensates for the attenuation of the signal resulting from the optical path. After the amplifier, one of the index signals is subtracted at 516 from the other one of the index signals. In one implementation of this embodiment, shown in FIG. 11, the subtraction is performed at a subtraction point 516. As a result of the subtraction a differential signal has been generated. This differential signal is forwarded to the control means via an I/V-converter 518. The function of the I/V-converter 518 is the same as that of the I/V-converter 368 of the level shifter in FIG. 6.

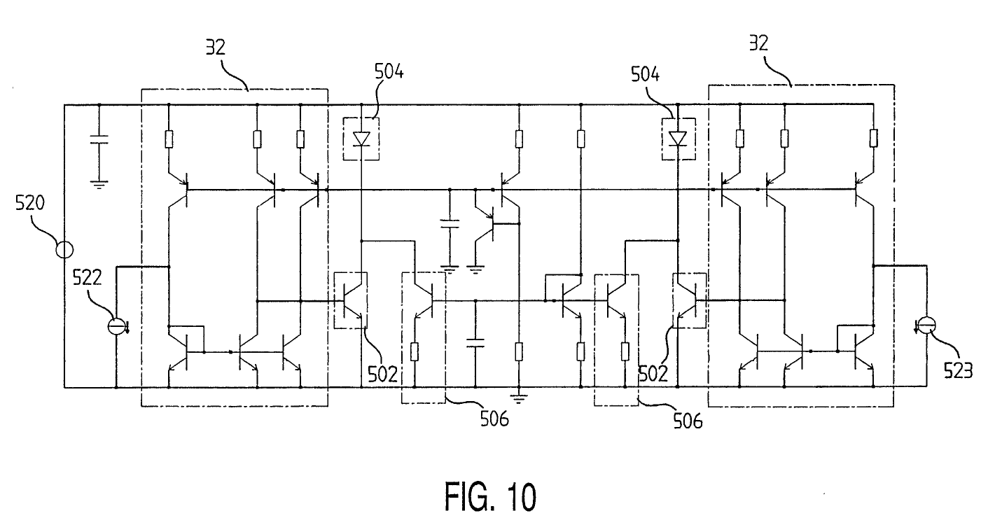

FIG. 10 shows an implementation of an embodiment of the high-voltage HV side of the level shifter in FIG. 9. The voltage source 520 in the Figure represents a local voltage supply for the low-voltage LV side of the level shifter. The current sources 522 and 523 correspond to the electron gun and the current which is generated when an electron beam impinges on the groups of index elements, respectively. The function of the circuit has already been described above in the description of FIG. 9 and the components referred to in the description of FIG. 9 are denoted by the same reference numerals in this Figure.

FIG. 11 shows an implementation of an embodiment of the low-voltage LV side of the level shifter of FIG. 9. The implementation utilizes one positive voltage feed and one negative voltage feed, illustrated by the voltage sources 526 and 527, respectively. The function of the circuit has already been described above in connection with the description of FIG. 9, and the components referred to in the description of FIG. 9 are denoted by the same reference numerals in this Figure.

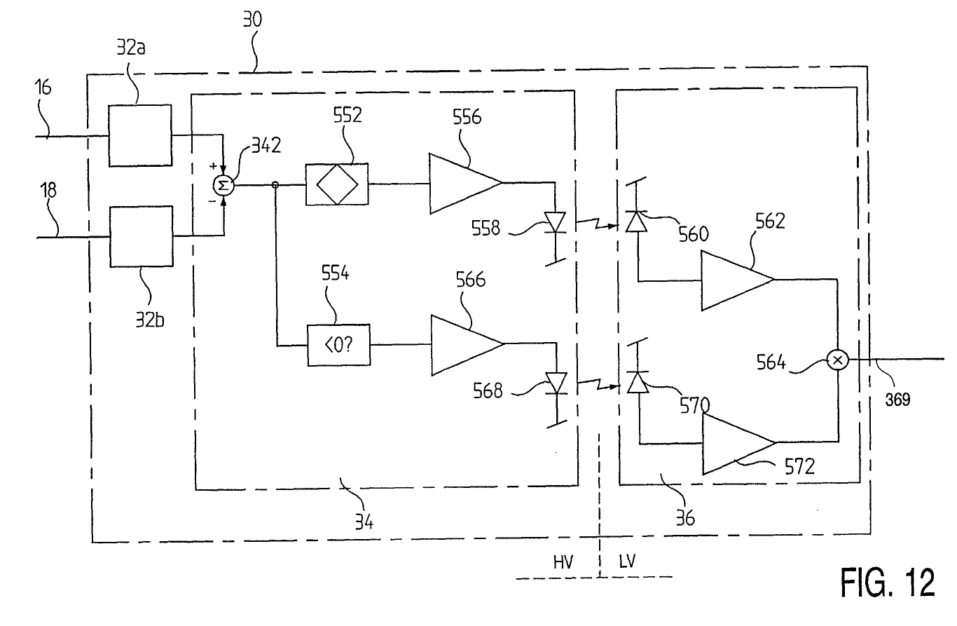

FIG. 12 shows yet another embodiment of the level shifter 30. The basic idea of this embodiment is to transmit the magnitude and the sign of a differential signal as separate signals via an optical path. In this embodiment, the index signal from each group of index elements is sent via the conductors 16, 18, respectively.

Each index signal is received at an input stage 32a, 32b. The input stages could be of any type previously described in this document. After the input stages 32a, 32b, one of the index signals is subtracted from the other index signal in a subtractor 342. The subtractor 342 then outputs a differential signal. A magnitude signal and a sign signal are extracted from the differential signal. In the preferred embodiment, the magnitude signal is obtained by means of a rectifier 552.

Thus, the magnitude signal includes no information regarding the sign of the differential signal. In the preferred embodiment, the sign signal is obtained by comparing the differential signal with zero, e.g. by arranging an operational amplifier as a polarity indicator 554. Thus, said sign signal includes information regarding the sign of the differential signal.

The magnitude signal is passed on to a LED 558 via an amplifier 556, which is arranged to optimize the signal in respect of the optical path. The LED 558 transmits the magnitude signal as light from the high-voltage side of the level shifter 30 to a photo-diode 560 at the low-voltage side of the level shifter 30. The photo-diode generates a current which is proportional to the received light and thereby proportional to the magnitude signal. The magnitude signal then passes an amplifier 562, which compensates for attenuation caused by the optical path. Then the magnitude signal is inputted to a multiplication circuit 564.

The sign signal is also passed to an LED 568 via a amplifier 566, which is arranged to optimize the signal in respect of the optical path. The LED 568 transmits the sign signal as light from the high-voltage side HV of the level shifter 30 to a photo-diode 570 at the low voltage side LV of the level shifter 30. The photo-diode generates a current which is proportional to the received light and thereby proportional to the sign signal. The sign signal then passes through an amplifier 572, which compensates for attenuation caused by the optical path. Then the sign signal is inputted to the same multiplication circuit 564 as the magnitude signal.

Thus, two different optical paths are used for the magnitude signal and the sign signal respectively. The multiplication circuit 564 reconstructs the differential signal by combining the magnitude signal with the sign signal, e.g. by multiplying the signals. The reconstructed differential signal is then sent from the level shifter to the control means. It is, however, also possible to send the magnitude signal and the sign signal to the control means without reconstructing the differential signal.

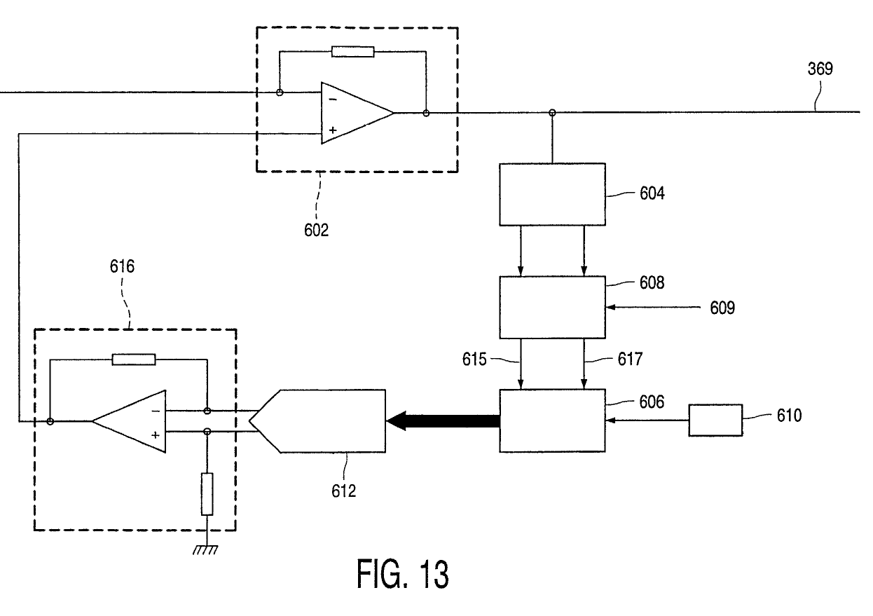

In one preferred embodiment of the present invention, the level shifter comprises an auto-calibrating circuit, schematically shown in FIG. 13. The purpose of the auto-calibrating circuit is to ensure that the zero-crossing of the transferred signal is transferred correctly, without offset. To be able to perform the calibration, the embodiment utilizes the fact that there are certain time intervals during a video frame during which the index signals are zero. For example, the index signals are zero when no beam current is present, e.g. during blanking, and when the electron beam does not imping on any of the index elements managed by the particular level shifter. Under these circumstances it is possible to calibrate the level shifter to output a zero-signal.

The auto-calibrating circuit preferably comprises a calibration loop that is built around an operational amplifier 602 positioned in the last stage of the level shifter. A window detector 604 detects the non-zero voltage at the output of the level shifter. The window detector 604 and a synchronizing signal 609 control a counter 606 via a logic circuit 608, which generates an enable signal 615 and an UP/DOWN signal 617. The logic circuit 608 and the synchronizing signal 609 make sure that calibration is only performed when the level shifter input is zero. The counter 606 is clocked by an oscillator 610 and drives a D/A converter 612. The buffered output from the D/A converter 612 is connected via a further amplifier 616 to the positive input of the operational amplifier 602 for adjusting the output level.

1. A picture display device comprising a cathode ray tube (2) provided with indexing elements (12, 14) for detecting an electron beam of the cathode ray tube (2) that impinges on said elements (12, 14), and a level shifter (30) for transmitting at least one signal, based on the detection at the indexing elements (12, 14), from a high-voltage system (20) of the cathode ray tube (2) to a low voltage-system of an electron beam control means 50;
characterized in that the level shifter (30) comprises an input stage (32a, 32b) which is arranged to decrease an input impedance (|Z|; |Z|₁₂) of the level shifter (30).

2. The picture display device as claimed in claim 1, wherein the input stage (32a, 32b) comprises a current mirror (32).

3. The picture display device as claimed in claim 1, wherein the input stage (32a, 32b) comprises an inverting current to voltage converter (32).

4. The picture display device as claimed in claim 1, wherein the input stage (32a, 32b) comprises at least two cascaded operational amplifiers (326, 328) and a feedback connection connecting (FBI₂) an output O₂ of the last operational amplifier (328) of the cascaded operational amplifiers (326, 328) to an input of the first operational amplifier (326) of the cascaded operational amplifiers (326, 328), said feedback connection (FB₁₂) including a resistor R₁₂.

5. The picture display device as claimed in claim 4, wherein one of the at least two operational amplifiers (326, 328) is arranged as an inverting current to voltage converter (32).

6. The picture display device as claimed in any one of the preceding claims, wherein the level shifter circuit (30) comprises at least one optical signal path (38) for transmitting said at least one signal and for providing galvanic separation between the high-voltage system (20) and a low voltage-system (22).

7. The picture display device as claimed in claim 6, wherein the optical path (38) comprises a light-emitting diode (346) for sending said at least one signal from the high-voltage system (20) and a photo-diode (362) for receiving said at least one signal at the low-voltage system (22).

8. The picture display device as claimed in claim 1 wherein the indexing elements (12, 14), comprising a first indexing element (12) and a second indexing (14) element, are arranged adjacent to each other and are arranged to generate a first indexing signal on an output conductor (16) and a second indexing signal on an output conductor (18), respectively.

9. The picture display device as claimed in claim 8, further comprising a subtraction means (342) for subtracting the second indexing signal from the first indexing signal and for generating a differential signal (343), indicating the difference between the first indexing signal and the second indexing signal.

10. The picture display device as claimed in claim 8 or 9, wherein the differential signal is transmitted from the high-voltage system (20) to the low voltage system (22) via an optical path (38).

11. The picture display device as claimed in claim 1; characterized in that the high voltage system (20) comprises the indexing elements (12, 14) and a high voltage side (HV) of the level shifter (30),
the indexing elements (12, 14) are connected via output conductors (16, 18) to the input stage (32a, 32b) of the level shifter (30),
low voltage system (22) comprises a low voltage side (LV) of the level shifter (30) and the electron beam control means (50),
an output (369) of the level shifter (30) is connected to the electron beam control means (50) for controlling the position of the electron beam that impinges on the indexing elements (12, 14).
